(19) United States
(12) Patent Application Publication
(10) Pub. No.: US 2005/0042907 A1
(43) Pub. Date: Feb. 24, 2005

(54) Connector

(76) Inventor: Ryuichi Komiyama, Tokyo (JP)

Correspondence Address: Barley Snyder, Suite 275, 1000 Westlakes Drive, Berwyn, PA, 19312, US

(21) Appl. No.: 10/938,034

(22) Filed: Sep. 10, 2004

(30) Foreign Application Priority Data
Sep. 10, 2003 (JP) 2003-318740

(51) Int. Cl. H01R 13/62

(52) U.S. Cl. 439/296

(57) ABSTRACT

The invention improves the operability of a connector including: a lock arm locked to a lock section of a mating connector; and a disengagement section receiving an outside force from a prescribed direction, brought into camming engagement with the lock arm, and releasing the lock arm from the lock section of the mating connector. The lock arm includes a lock section locked to the lock section of the mating connector, a camming engagement section bought into camming engagement with the disengagement section, and an operation section that receives an outside force from a direction other than the prescribed direction when the disengagement section is in an unoperated state, releasing the lock arm from the lock section of the mating connector. The operation section is exposed to the outside with the connector fitted to the mating connector.

### FIELD OF THE INVENTION

The present invention relates to a connector having a lock arm that is locked to a lock section of a mating connector, and a disengagement section that receives an outer force from a prescribed direction, is brought into camming engagement with the lock arm, and releases the locking of the lock arm to the lock section of the mating connector.

### BACKGROUND OF THE INVENTION

A typical method for interconnecting of wires is to provide connectors at the leading ends of the wires and engage the connectors with each other. To positively maintain electrical connection, the connectors must remain engaged with each other. Many connectors re provided with a lock mechanism in order to ensure that the mutual engagement of the connectors is not unintentionally released. Connectors with locking systems have been proposed, for example, in Japanese Patent Laid-Open No. 10-154550 and Japanese Utility Model Laid-Open No. 57-201778).

These connectors are provided with a lock arm that is locked to a mating connector upon fitting the respective connector to its mating connector and a disengagement section that operates to release the lock arm from the lock section of the mating connector when the disengagement section is operated. To release the engagement of these connectors wit their mating connectors, it is necessary to release the lock arm from the mating connector by operating the disengagement section.

In the connector described in Japanese Patent Laid-Open No. 10-154550, however, the disengagement section is provided on a side surface that spreads on both sides of the engaging surface with the mating connector. Therefore, it is impossible to perform operations from above. In the connector described in Japanese Utility Model Laid-Open No. 57-201778, the disengagement section is provided on an upper surface that spreads above the engaging surface with the mating connector. Therefore, it is impossible to perform operations from sides. Thus, these connectors have a problem in operability.

Furthermore, the disengagement section may be given another function in addition to the function of releasing the lock arm from the mating connector. Then, when the disengagement operation is performed to release the lock arm from the mating connector, at the same time, this other function is also performed.

### SUMMARY

The present invention has been made in view of the above circumstances and provides a connector which has a lock arm locked to a lock section of a mating connector and a disengagement section that receives an outside force from a prescribed direction, bringing it into camming engagement with the lock arm, and releasing the lock arm from the lock section of the mating connector. The lock arm has a lock section that is locked to the lock section of the mating connector, a camming engagement section that is bought into camming engagement with the disengagement section, and an operation section that receives an outside force from a direction other than the prescribed direction when the disengagement operation section is in an unoperated state, releasing the lock arm from the lock section of the mating connector. The operation section is exposed to the outside when the connector is fitted to the mating connector.

### BRIEF DESCRIPTION OF THE DRAWINGS

FIG. 1 is a perspective view of a door frame to be disposed within a door panel of an automobile;

FIG. 2 is a sectional view of a holding section provided in the door frame shown in FIG. 1, taken along the longitudinal direction of the door frame;

FIG. 3 is an exploded perspective view of a female connector and a male, mating connector, according to an exemplary embodiment of the invention; and

FIGS. 4a1-4c2 show, by stages, the work of fitting the male, mating connector attached to a door handle into the female connector shown in FIG. 3, which is held by the door frame shown in FIG. 1, and also shows the situation during the turning of the door handle. FIGS. 4a1, 4b1, and 4c1 are sequential detail views of a guide groove in the door frame and projections on the female connector. FIGS. 4a2, 4b2, and 4c2 are sequential sectional views of the door handle and door frame corresponding to the fitting stages of FIGS. 4a1, 4b1, and 4c1, respectively.

### DETAILED DESCRIPTION OF THE EMBODIMENT(S)

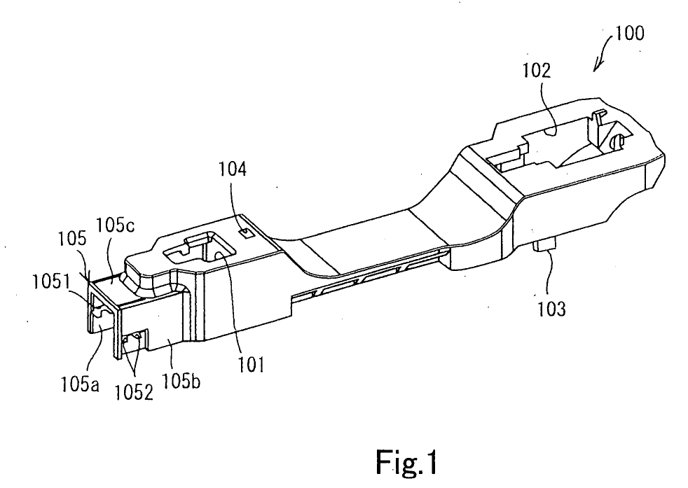

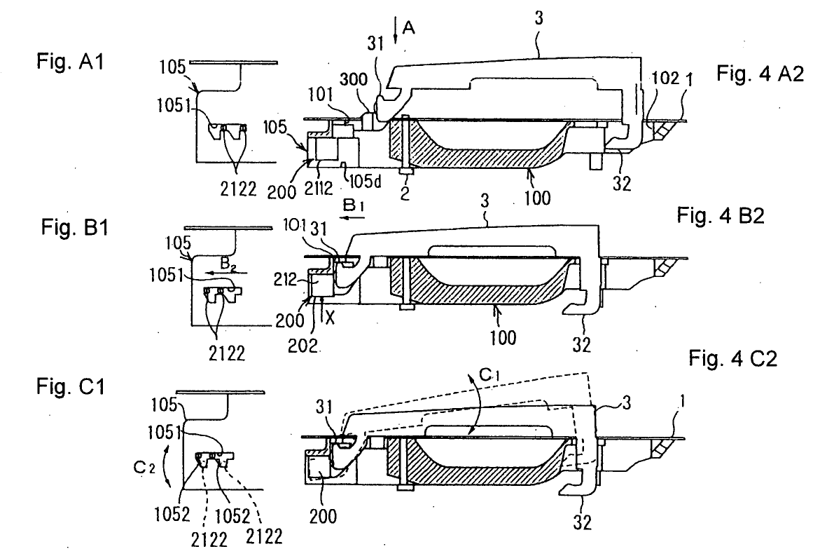

In an exemplary embodiments of the invention, a female connector is held by a door frame 100 within a door panel of an automobile. The door frame 100, shown in FIG. 1, is attached to the inside of a door panel 1 (see FIG. 4a), which is not shown in FIG. 1. A door handle 3 (see FIG. 4a), which is not shown in FIG. 1, is incorporated into the door frame 100. A sensor (not shown), that detects prescribed signals, is built into this door handle 3 that is incorporated into the door frame 100, and an automobile to which this door handle 3 is attached has a control that unlocks the door when the sensor detects a prescribed signal. Prescribed signals are constantly sent out by an ignition key that the user of the automobile has. For this reason, when a person who has the ignition key approaches the automobile, the door is automatically unlocked.

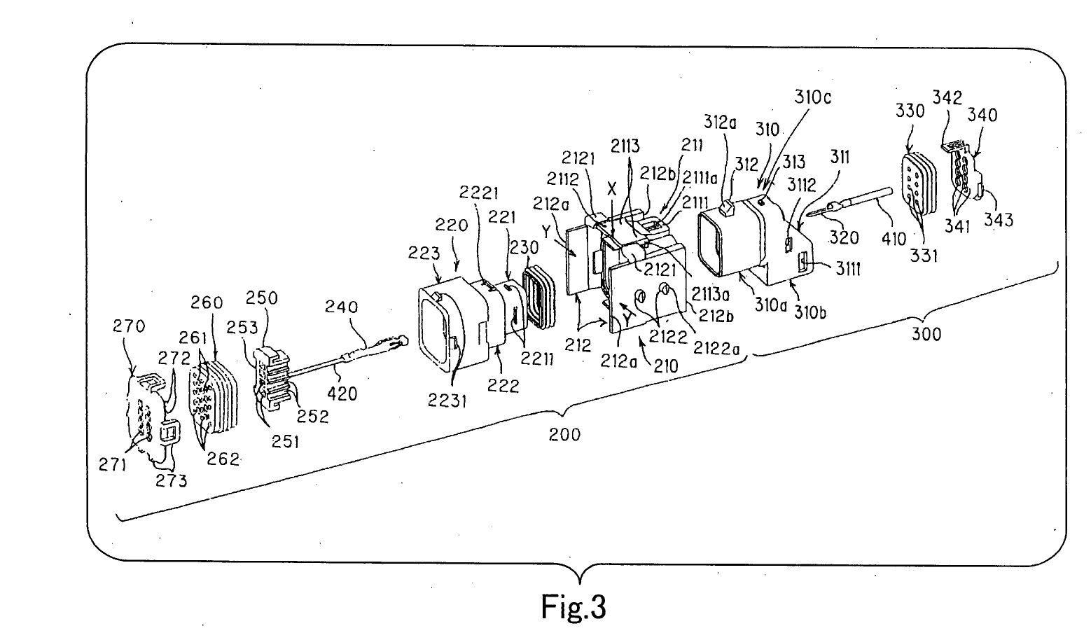

A male connector 300 (see FIG. 3) is attached to an end of the handle 3 at which the handle pivots with respect to the door frame 100. A wire extends from the sensor that is built into the door handle 3 and the leading end of the wire is introduced into this male connector 300.

Insertion holes 101, 102, respectively are provided in the two ends of the door frame 100 shown in FIG. 1. The end of the door handle 3 at which the handle pivots with respect to the door frame 100 is inserted into the small insertion hole 101, which is shown in the left area of FIG. 1, and the end of the door handle on a side opposite to the pivot end is inserted into the large insertion hole 102, which is shown in the right area of FIG. 1. A pair of anti-rattle projections 103, spaced in the width direction of this door frame 100, project from under the end of the door frame 100 in which the large insertion hole 102 is provided. The end of the door handle 3 inserted from the large insertion hole 102 enters the space between the pair of anti-rattle projections 103 and rattling of the door handle in the width direction is prevented. A screw hole 104 is provided near the small insertion hole 101 of the door frame 100. This door frame 100 is attached to the door panel by a screw 2 (see FIG. 4) that is screwed into this screw hole 104. A holding section 105 that holds a female connector 200 (see FIG. 3) is provided at the leading part of the end where the small insertion hole 101 is provided. The holding section 105 shown in FIG. 1 is an angled U-shaped section that opens downward and has side walls 105a, 105b that are opposite to each other and an upper wall that connects upper edges of these side walls 105a, 105b. Communication is provided between the inner surface of this holding section 105 and the small insertion hole 101, and a guide groove 1051 and two pivot grooves 1052 are provided in each of the side walls 105a, 105b that are opposite to each other.

The guide grove 1051 provided in the holding section 105 shown in FIG. 1 is a through groove that extends horizontally in the longitudinal direction of the door frame shown in FIG. 1. The two pivot grooves 1052 are through grooves that extend downward each from the guide groove 1051 at a prescribed spacing.

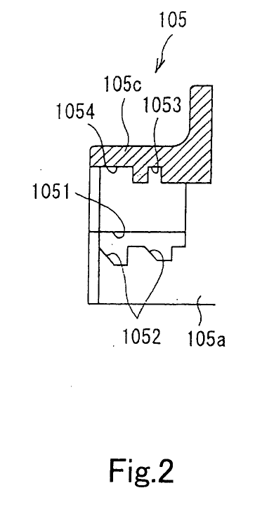

As shown in FIG. 2, two notches 1053, 1054 are provided in the inner surface of an upper wall 105c of the holding section 105 shown in FIG. 1. These two notches 1053, 1054 are spaced in the extending direction of the guide groove 1051 shown in FIG. 2.

FIG. 3 is an exploded perspective view of the female connector 200 and the male connector 300, which is a mating connector of the female connector 200. In the right area of FIG. 3, the male connector 300 is shown in an exploded state. This male connector 300 has a housing 310, a male contact 320, a collecting rubber plug 330, and a cover member 340.

A conductor 410 is connected to the male contact 320 shown in FIG. 3. Although only one male connector 320 is shown in FIG. 3, the wiring introduced in the male connector 300 shown in FIG. 3 is constituted by eight conductors and in actuality there are eight male contacts 320 in the exemplary embodiment.

The housing 310 shown in FIG. 3 has a main section 310c, and a hood section 310a and a wing section 310b that extend from the main section 310c forward and backward and downward, respectively. The eight contacts 320 are housed between the hood section 310a and the main section 310c, and a large locking projection 312 is provided on the outer circumference of the hood section 310a. A pair of latch arms 311 is provided in the wing section 310b. A small locking projection 313 is provided on an upper surface of the main section 310c.

The pair of latch arms 311 are provided on both sides of the housing 310 and project in a direction opposite to the mating direction of the male connector 300 with the female connector 200. Each of the pair of latch arms 311 has a large locking hole 3111 and a small locking hole 3112. The male connector 300 shown in FIG. 3 is detachably attached to the door handle 3 (see FIG. 4) by the pair of latch arms 3112.

The collecting rubber plug 330 shown in FIG. 3 is a plate-like rubber member having eight through holes 331. Each of the eight conductors 410 is inserted into a corresponding one of these eight through holes 331. This collecting rubber plug 330 is provided at the wiring introduction port of the male connector 300. Therefore, any water that has flowed along the wiring is prevented by this collecting rubber plug 330 from entering the interior of the male connector 300 and the connector 300 is positively rendered waterproof.

Also the cover member 340 shown in FIG. 3 has eight through holes 341 that correspond to the eight through holes 331 provided in the collecting rubber plug 330, and each of the conductors 410 is inserted into each of the through holes 341. Furthermore, this cover member 340 also has a locking member 342 and a locking claw 343. The small projection 313 provided in the main section 310c of the housing 310 enters the locking member 342. The locking claw 343 is provided on both sides of this cover member 340 and enters the small locking hole 3112 provided in the pair of latch arms 311 of the housing 310. When the locking projection 313 enters the locking member 342 and at the same time the locking claw 343 enters the locking hole 3112, the cover member 340 is fixed to the housing 310 while holding the collecting rubber plug 330.

Now the assembly process of the male connector 300 shown in FIG. 3 will be described.

The leading ends of each of the eight conductors 410 are first inserted into the eight through holes 341 of the cover members 340 and then also into the eight through holes 331 of the collecting rubber plug 330. Subsequently, wire connection work is performed. In this wire connection work, each of the leading ends of the eight conductors 410 is crimped onto each of the eight male contacts 320. Next, the eight male contacts 320 are housed in the housing 310. A lance (not shown) is provided at each of the male contacts 320, and this lance is locked to the housing 310. This locking enables the position and posture of each of the male contacts 320 within the housing 310 to be fixed. After that, the collecting rubber plug 330 is fitted into the housing 310 and lastly, the cover member 340 is attached to the housing 310.

Next, the female connector 200 of this embodiment will be described. In the left area of FIG. 3, the female connector 200 is shown in an exploded view. Wiring conductors 420 is introduced in this female connector 200. The conductors 420 extend from the control section of a vehicle carrying a signal that unlocks the door. The female connector 200 has an outer housing 210, an inner housing 220, a seal ring 230, a female contact 240, a secondary locking member 250, a collecting rubber plug 260, and a cover member 270.

The outer housing 210 is formed from a very flexible plastic material. The outer housing 210 comprises a lock arm 211 and a pair of disengagement sections 212, which are integrally provided. For this reason, the number of parts decreases and the connector assembling time is short, and hence the cost of the female connector 200 is low. The lock arm 211 has a lock section 2111 at one end thereof and an operation section 2112 at the other end thereof. The lock section 2111 has a locking hole 2111a. The large locking projection 312 provided in the hood section 310a of the male connector 300 shown in FIG. 3 has a tapered surface 312a. In fitting the male connector 300 shown in FIG. 3 and the female connector 200 of this embodiment together, the lock section 2111 of the female connector 200 is raised by the tapered surface 312a of the locking projection 312 provided on the male connector 300. When the two are to be further fitted together, the locking projection 312 enters the locking hole 2111a of the lock section 2111 and the two become locked together. The locking of the two can be released by separating the two, with the lock section 2111 kept in a raised state. The operation section 2112 on the opposite side of the lock arm 211 is exposed to permit access from the outside and the lock section 2111 is raised pushing the operation section 2112, such as by pressing with a finger, thereby deflecting the operation section 2112. A camming engagement section 2113 is provided on both sides of the operation section 2112. The camming engagement section 2113 has a tapered surface 2113a that are inclined toward both sides of the outer housing 210. This tapered surface 2113a is inclined so as to approach both sides of the outer housing 210 in the pushing-in direction of the operation section 2112.

The pair of disengagement sections 212 is provided on both sides of the outer housing 210 and projects from both sides of the engaging surface of this female connector 200 to a side opposite to the fitting direction. When the leading ends 212a of the disengagement sections 212 in the projecting direction are pinched in so as to approach each other, the pair of disengagement sections 212 is deflected, with a tail end 212b in the projecting direction (the right end in FIG. 3) serving as a turning axis. The pair of disengagement sections 212 has a bent piece 2121 that is bent toward the camming engagement section 2113 of the lock arm 211. The leading end surface of this bent piece 2121 on the camming engagement section 2113 side is substantially parallel to the taper of the tapered surface 2113a of the camming engagement section 2113. When the leading ends 212a of the disengagement sections 212 in the projecting direction are pinched in so as to approach each other, the bent piece 2121 is brought into camming engagement with the camming engagement section 2113 of the lock arm 211, the operation section 2112 is pushed down, and the lock section 2111 is raised. Each of the pair of disengagement sections 212 has two projections 2122 that are disposed side by side in the horizontal direction. These projections 2122 are inserted into a guide groove 1051 of the door frame 100 shown in FIG. 1. Projecting leading end surfaces 2122a of these projections 2122 are chamfered on the front side of the insertion direction so as to be easily inserted into the door frame 100. When these projections 2122 are inserted into the guide groove 1051 of the door frame 100, the female connector 200 shown in FIG. 3 is first held by the door frame 100 in a prescribed waiting position for waiting for the male connector that is the mating connector. At this time, a locking projecting section (not shown) provided on a side opposite to the side where the lock arm 211 of the outer housing 210 is provided, enters the notch 1053 that is nearer to the insertion hole 102 shown in FIG. 1 than the notch 1054, the two notches 1053, 1054 being shown in FIG. 2. When the locking projecting section has entered this notch 1053, the female connector 200 cannot easily move or change its position. Therefore, when the connector 200 fits onto the mating male connector, the female connector 200 waits for the mating male connector while maintaining its proper position and, therefore, it is possible to smoothly perform the fitting work of the two.

When the female connector 200 shown in FIG. 3 has been fitted onto the mating male connector, this fitting can be released by separating the two from each other, with the leading ends 212a of the pair of disengagement sections 212 provided in the female connector 200 in the projecting direction pinched in so as to approach each other. Furthermore, the projections 2122 inserted into the guide groove 1051 of the door frame 100 are caused to disengage by the operation of pinching in the pair of disengagement operation sections 212, which is performed at this time, and hence this female connector 200 can also be removed from the door frame 100. The operation section 2112 of the lock arm 211 is exposed to the outside even when this female connector 200 is fitted onto the male connector 300 shown in FIG. 3. Therefore, it is possible to release the female connector 200 shown in FIG. 3 from the male connector 300 by pressing on the exposed operation section 2112 to push in the operation section 2112 as well as by pinching in the leading ends 212a of the disengagement operation sections 212 in the projecting direction. The direction in which the operation section 2112 of the lock arm 211 is pushed in (see the arrow X) and the direction in which the pair of disengagement sections 212 is pinched in (see the arrow Y) are orthogonal to each other, and in this female connector 200, it is possible to release the locking of the lock arm 211 to the lock section 2111 of the male connector 300, which is the mating connector, by applying force from two different directions. Thus, this female connector 200 is improved in operability compared to conventional connectors. In addition, the disengagement section 212 is not affected at all by pushing in the operation section 2112 of the lock arm 211. Therefore, by pushing in the operation section 2112, it is possible to release the fitting of this female connector 200 onto the male connector 300, while the female connector 200 continues to be held by the door frame 100. Thus, this female connector 200 is further improved in operability.

One conductor 420 is connected to the female connector 240 shown in FIG. 3. In FIG. 3, as with the male connector 320, only one female contact 240 is shown. However, the wiring that is introduced into the female connector 200 shown in FIG. 3 is constituted by eight conductors, as with the wiring introduced in the male connector 300, and in actuality the number of female contacts 240 is eight.

The inner housing 220 shown in FIG. 3 is formed from a plastic material to which a glass material is added, and is poor in flexibility. Therefore, the dimensional accuracy of the inner housing 220 is maintained at a high level. This inner housing 220 has three main sections, which are respectively large, medium and small in size. The eight female contacts 240 are housed in the inner housing 220 so that the leading ends thereof are located within a small main section 221. Multiple locking projections 2211 that lock the seal ring 230 are provided on the outer circumference of the small main section 221. The inner housing 220 is for insertion into the outer housing 210, and a locking projection 2221 that locks the outer housing 210 is provided on the outer circumference of a medium main section 222 of the inner housing 220. Furthermore, multiple locking projections 2231 that lock the cover member 270 are provided on the outer circumference of a large main section 223 of the outer housing 220.

The secondary locking member 250 is for holding the eight female contacts 240. In FIG. 3, this secondary locking member 250 has four closed cavities 251 that are disposed in a line and four open cavities 252 that are disposed in a line. The back half (the left half in the drawing) of each of the eight female contacts 240 is housed in these cavities 251, 252. This secondary locking member 250 has a concavity 253 into which a jig is inserted during assembling.

The collecting rubber plug 260 is provided at the wiring introduction port of the female connector 200. Therefore, even when this female connector 200 is held by the door frame 100 shown in FIG. 1 and water from the outside reaches the side of the wiring introduction port of the female connector 200 along the door frame 100 and the like, this water is prevented by this collecting rubber plug 260 from entering the interior of the female connector 200 and the connector is positively rendered waterproof. In FIG. 3, this collecting rubber plug 260 is a plate-like rubber member having a total of eight through holes 261 that are disposed in two lines, with four holes per line. Each of the eight conductors 420 is inserted into a corresponding one of these eight through holes 261. In addition to these through holes 261, this collecting rubber plug 260 has a total of 15 concavities 262 that are disposed in three lines, with five concavities per line.

Also the cover member 270 has eight through holes 271 corresponding to the eight through holes 261 provided in the collecting rubber plug 260, and each of the eight conductors is inserted into one of the through holes 271. Also this cover member 270 has 15 convexities 272 corresponding to the 15 concavities 262 provided in the collecting rubber plug 260. Furthermore, the cover member 270 has locking members 273 into which the locking projections 2231 provided in the large main section 223 of the inner housing 220 project.

Now the assembly process of the female connector 200 shown in FIG. 3 will be described. The leading end of each of the eight conductors 420 is first inserted into the eight through holes 271 of the cover members 270 and then also into the eight through holes 261 of the collecting rubber plug 260. Subsequently, wire connection work is performed. In this wire connection work, each of the leading ends of the eight conductors 420 is crimped onto one of the eight female contacts 240. Also at his time, the secondary locking member 250 is placed in the inner housing 220, the small main section 211 of the inner housing 220 is covered with the seal ring 230, and the seal ring 230 is locked by the multiple locking projections 2211 provided in the small main section 221. Next, the female contacts 240, to which the conductors 210 have been connected, are inserted into the secondary locking member 250 in the inner housing 220. A lance (not shown) is provided in each of the female contacts 240. When the female contact 240 is inserted until the leading end of the female contact 240 reaches the interior of the small main section 221 of the inner housing 220, this lance is locked to the inner housing 220 and the position of each female contact 240 within the inner housing 220 is fixed. Then, by inserting a jig into the concavity 253 provided in the secondary locking member 250 within the inner housing 220, the secondary locking member 250 is caused to slide toward the operator (downward) in the drawing. As a result of this, each female contact 240 is locked to the secondary locking member 250 and held by the secondary locking member 250. Then, the collecting rubber plug 260 is inserted into the large main section 223 of the inner housing 220 and the cover member 270 is then attached to the inner housing 220. In attaching the cover member 270, each of the multiple locking members 273 of the cover member 270 is locked to the locking projection 2231 provided in the large main section 223 of the inner housing 220. Lastly, the inner housing 220 is attached to the interior of the outer housing 210. In attaching this inner housing 220, the locking projection 2221 provided in the medium main section 222 of the inner housing 220 is locked to the outer housing 210. When the female connector 200 thus assembled and the mating male connector are fitted together, the engaging surfaces of the two are positively rendered waterproof by the seal ring 230 provided in the female connector 200.

Next, with reference to FIGS. 4a-4c, a description will be given of fitting the female connector 200 of this embodiment shown in FIG. 3 and the male connector 300 also shown in FIG. 3.

As shown in FIG. 4a2, the door handle 3 is inserted partway into the large insertion hole 102 of the door frame shown in FIG. 1, at an end of the door handle 3 opposite to the end at which the male connector 300 is attached. The door frame 100 is attached to the inside of the door panel 1 by the screw 2. The female connector 200, shown in FIG. 3, is held by the door frame 100 by inserting the projection 2122 of this female connector 200 into the guide groove 1051 provided in the holding section 105 of the door frame 100. As shown in FIG. 4a2, the female connector 200 is held in a prescribed waiting position obtained by turning the female connector shown in FIG. 3 upside down. Therefore, the operation section 2112 provided in the female connector 200, which is shown in FIG. 3, is located at an opening 105d sandwiched between a pair of side walls of the holding section 105 provided in the door frame 100, and the engaging surface faces the insertion hole 101 of the door frame 100. Furthermore, as shown in the left area of FIG. 4a1, the projections 2122 provided on the female connector 200 are located on the insertion hole 101 side within the guide groove 1051 of the holding section 105. Furthermore, the locking projecting section (not shown) of the female connector 200 enters the notch 1053 (see FIG. 2), and the female connector 200 waits for the mating male connector 300 in a prescribed waiting position.

An end 31 of the door handle 3 at the pivot point, to which the male connector 300 is attached, is inserted from the insertion hole 101 in the direction of the arrow A in the drawing. In association with this insertion, an end 32 of the door handle 3, on a side opposite to the pivot point, is also inserted into the insertion hole 102.

FIG. 4b2 is a drawing that shows how the female connector 200 shown in FIG. 3 and the mating male connector 300 are fitted together by causing the door handle to slide. Each of the ends 31, 32 of the door handle 3 is inserted deep into the door frame 100. When in this state, the door handle 3 is caused to slide in the direction of the arrow B₁, whereby the male connector 300 attached to the door handle 3 is pushed into the female connector 200 held in a prescribed waiting position and the two become fitted together. At this time, the female connector 200 held in a prescribed position is pushed by the male connector 300 and moves back to a prescribed fitting completion position. As shown in FIG. 4b2, the projection 2122 provided in the female connector 200 moves within the guide groove 1051 of the holding section 105 to a position remotest from the insertion hole 101 (see the arrow B₂). The locking projecting section of the female connector 200 enters the notch 1054 that is more remoter from the insertion hole 102.

The female connector 200 and male connector 300 fitted together as described above change their position in one piece in association with the turning operation of the door handle 3.

FIG. 4c2 is a drawing that shows how the door handle is turned. The door handle 3 turns by using the end 31 to which the male connector 300 is attached as a pivot point. The state of the turn of the door handle 3 from the state shown in FIG. 4b2 is indicated by dotted lines. When the door handle 3 turns (see the arrow C₁), the end 32 of the door handle 3 on a side opposite the pivot point is raised and the door handle 3 becomes slanted with respect to the door panel 1. At this time, as shown in the FIG. 4c1, the projection 2122 provided in the female connector 200 can move from the guide groove 1051 of the holding section 105 into the pivot groove 1052. Therefore, the female connector 200, along with the mating male connector, is also allowed to become slanted (see the arrow C₂).

The fitting of the female connector 200 and the male connector 300 can be released by pushing in the operation section 2112 of the lock arm provided in the female connector 200 in the direction of the arrow X in FIG. 4b2 or by pinching in the pair of disengagement sections 212 in a direction vertical to the drawing surface in FIG. 4b2. Furthermore, when the pair of disengagement sections 212 is pinched in, the projection 2122 that has been inserted into the guide groove 1051 of the door frame 100 comes off and hence it is possible to remove this female connector 200 from the door frame 100.

The exemplary embodiment provided above is meant to be illustrative of the invention and the invention should not be interpreted to be limited thereto. Rather, alternative embodiments are contemplated within the scope of the invention. For example, a connector according to the present invention can also be applied to a male connector as well as a female connector, and to connectors having various applications in addition to a connector held by a door frame of an automobile.

1. A connector comprising:
a lock arm that is locked to a lock section of a mating connector; and
a disengagement section that is brought into camming engagement with the lock arm by an outside force from a prescribed direction, and releases the lock arm from the lock section of the mating connector,
wherein the lock arm comprises:
a lock section that is locked to the lock section of the mating connector;
a camming engagement section that is bought into camming engagement with the disengagement section; and
an operation section that receives an outside force from a direction other than the prescribed direction when the disengagement section is in an unoperated state, releasing the lock arm from the lock section of the mating connector, the operation section being exposed to the outside when the connector is fitted to the mating connector.

2. The connector according to claim 1, wherein the lock arm and the disengagement section are integrally formed with each other.

3. The connector according to claim 2, wherein the integral lock arm and the disengagement section are pivotally connected to a housing that houses the connector.

4. The connector according to claim 1, wherein the connector or the mating connector is attached to a pivoting member and the other one of the connector or the mating connector is held in a fixed frame prior to mating of the connectors.

5. The connector according to claim 4, wherein the other one of the connector or the mating connector is held in a fixed frame prior to mating of the connectors by a guide groove having pivot grooves to allow the pivot member to pivot with respect to the frame.

6. The connector according to claim 5, wherein the connector has a projection opposite the lock arm and the fixed frame has notches for receiving the projection to hold the connector in place.
